(19) United States
(12) Patent Application Publication
(10) Pub. No.: US 2007/0209709 A1
(43) Pub. Date: Sep. 13, 2007

(54) Valve device and liquid ejection device

(75) Inventors: Kazutoshi Shimizu, Nagano-ken (JP); Masaru Takahashi, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/706,641

(22) Filed: Feb. 13, 2007

(30) Foreign Application Priority Data
Feb. 13, 2006 (JP) P2006-035414

(51) Int. Cl. F16K 29/00

(52) U.S. Cl. 137/331

(57) ABSTRACT

A valve device comprises a flow passage, a storage chamber, a valve seat, a diaphragm, a valve-closing unit, and a first biasing member. A fluid passes through the flow passage. The storage chamber is disposed in the flow passage for storing the fluid. The storing chamber includes an opening. The valve seat includes a communicating hole for releasing the fluid in the storage chamber through the communicating hole to the outside. The diaphragm operates to cover the opening of the storage chamber and displaces relative to the valve seat. The valve-closing unit brings the diaphragm into contact with the valve seat so as to block the communicating hole. The first biasing member expands a clearance between the diaphragm and the valve seat to open the valve device.

### CROSS-REFERENCE TO RELATED APPLICATIONS

This application is based upon and claims the benefit of priority from prior Japanese Patent Application No. 2006-035414, filed on Feb. 13, 2006, the entire content of which is incorporated herein by reference.

### FIELD OF THE INVENTION

The present invention relates to a valve device and a liquid ejection device.

### BACKGROUND OF THE INVENTION

As a liquid ejection device for ejecting liquid from a liquid ejection head onto a target, an ink-jet printer exists. In the printer, ink is supplied from a cartridge that stores ink as a liquid to a recording head that serves as a liquid ejection head and that is mounted on a carriage. Then, the recording head is driven so as to eject ink toward paper as a target. One example of the printers is a so-called off-carriage printer. In a printer of this type, in order to make the size of the device small and reduce the load on the carriage, a cartridge is disposed at a location other than the carriage.

A printer of this type includes an ink supply mechanism for supplying ink from the cartridge to the recording head by way of an ink flow passage made of an item such as a tube. In order to supply ink to the recording head in the face of pressure loss and gravity within the flow passage, the ink supply mechanism pressurizes the ink stored in the cartridge into ink flow passage in order to send the ink to the recording head.

As an ink supply mechanism as described above, an ink supply mechanism for pumping air into the cartridge including a case and an ink pack has been proposed. The air supply mechanism includes a pressurizing pump, an air flow passage for supplying air into the case of the cartridge, and a pressure regulating device. The ink pack is made of a flexible material and the pressure of the air that is charged into the case crushes the ink pack. As a result, ink that is charged in the ink pack is pushed into the ink flow passage.

When the pressurized air supplied to the cartridge reaches a predetermined value or higher, the pressure regulating device releases the pressure to regulate the pressure applied to the cartridge so as to fall within a predetermined range. As an example of such pressure regulating device, Japanese Unexamined Patent Publication No. 2002-211002 discloses a pressure regulating valve equipped with a drive lever and a diaphragm valve. The diaphragm valve is a channel—like rubber molded article which is molded into a shape such that it does not block the air communicating hole when no external force is applied to the diaphragm valve. When the drive lever is moved downward, a supporting shaft interlocked with the drive lever presses the diaphragm valve toward the air communicating hole by a biasing force, and, in response to the pressing force, the diaphragm valve is elastically deformed. As a result, the air communicating hole is blocked and the valve is forcedly closed. At this point, if the pressure in the air chamber inside the pressure regulating valve increases excessively, the diaphragm valve, by virtue of the air pressure acting against the biasing force of the spring member, warps in a direction away from the air communicating hole so as to release the air in the air chamber to the outside. In contrast, when the drive lever is moved upward, the drive lever pulls up the supporting shaft, so that the diaphragm valve, by virtue of its elasticity, returns to its original shape so as to open the air communicating hole.

Recently, because of the high costs of a rubber molded article, a diaphragm valve in the shape of a thin film made of synthetic resin has been increasingly employed. Unlike a diaphragm valve made of a rubber molded article, such film is cheap since steps of designing and injection molding are eliminated.

However, a diaphragm valve made of film is inferior to a diaphragm valve made of a rubber molded article in terms of elasticity. For this reason, when pressure inside the air chamber reaches a predetermined value or higher, the film displaces in a direction of valve opening by the air pressure but the clearance between the diaphragm valve and the air communicating hole becomes very small. Accordingly, when the air in the air chamber flows through this minute clearance to the air communicating hole, the flow rate thereof increases, resulting in the occurrence of vibration and unusual sounds.

### SUMMARY OF THE INVENTION

An objective of the present invention is to provide a valve device and a liquid ejection device that are capable of preventing the occurrence of vibration or unusual sounds.

According to an aspect of the invention, a valve device is provided. The valve device comprises a flow passage, a storage chamber, a valve seat, a diaphragm, a valve-closing unit, and a first biasing member. The fluid passes through the flow passage. The storage chamber is disposed in the flow passage for storing the fluid. The storing chamber includes an opening. The valve seat includes a communicating hole for releasing the fluid in the storage chamber through the communicating hole to the outside. The diaphragm operates to cover the opening of the storage chamber and that displaces relative to the valve seat. The valve-closing unit brings the diaphragm into contact with the valve seat so as to block the communicating hole. The first biasing member expands a clearance between the diaphragm and the valve seat to open the valve device.

According to another aspect of the invention, a valve device for regulating a pressure of the fluid passing through a flow passage is provided. The valve device comprises a housing, a storage chamber, a valve seat, a diaphragm, a valve-closing unit, and a first biasing member. The housing is disposed in the flow passage. The housing has an inlet hole and an outlet hole. The storage chamber is disposed in the housing for storing the fluid. The storing chamber includes an opening. The fluid is introduced into the storage chamber through the inlet hole and discharged from the storage chamber through the outlet hole. The valve seat extends into the storage chamber. The valve seat includes a communicating hole for releasing the fluid in the storage chamber through the communicating hole to the outside. The diaphragm operates to cover the opening of the storage chamber and that displaces relative to the valve seat. The valve-closing unit brings the diaphragm into contact with the valve seat so as to block the communicating hole. The first biasing member is disposed on the inside of the valve seat. The first biasing member biases the diaphragm for expanding a clearance between the diaphragm and the valve seat to open the valve device.

According to yet another aspect of the invention, a liquid ejection device including the valve device as described above is also provided.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with the objects and advantages thereof, may best be understood by reference to the following description of the presently preferred embodiments in combination with the accompanying drawings in which:

FIG. 1 is a plan view of a printer of an embodiment of the present invention.

FIG. 2 is a partially enlarged cross-sectional view of a cartridge.

FIG. 3 is a perspective view of a pressurizing unit.

FIG. 4 is a perspective view of a pressure regulating valve.

FIG. 5 is a cross-sectional view of the pressure regulating valve in an open state.

FIG. 6 is a cross-sectional view of the pressure regulating valve in a closed state.

FIG. 7 is a partially enlarged cross-sectional view of the pressure regulating valve in a closed state.

FIG. 8 is a partially enlarged cross-sectional view of the pressure regulating valve in a state in which it is opened to atmospheric air.

### DESCRIPTION OF EXEMPLARY EMBODIMENTS

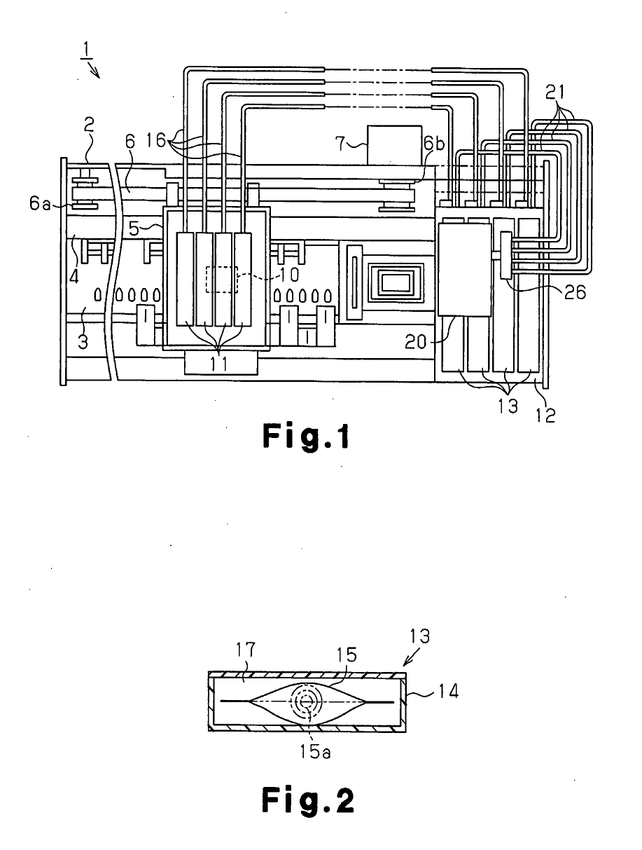

Hereinafter, an embodiment of the present invention will be described with reference to FIGS. 1 to 8.

FIG. 1 is a plan view illustrating a schematic structure of an ink-jet printer serving as a liquid ejection device. As shown in FIG. 1, the printer 1 includes a frame 2 and a platen 3 is mounted on the frame 2. Papers are fed onto the platen 3, by a paper-conveying mechanism that has a paper-conveying motor (not shown). Further, a bar-like guide 4 is mounted on the frame 2 so as to extend in parallel with the longitudinal direction of the platen 3. A carriage 5 is penetrated and supported by the guide 4 so as to be reciprocally movable in an axial direction of the guide 4. The carriage 5 is connected to a carriage motor 7 by means of a timing belt 6 that stretches between the pulleys 6a, 6b so that the carriage 5 is driven by the carriage motor 7. Thus, the carriage 5 is driven by the carriage motor 7 so as to move reciprocally along the guide 4.

A recording head 10 that serves as a liquid ejection head is mounted on the surface of the carriage 5 opposite to the platen 3. The valve units 11 for supplying fluid or liquid ink to the recording head 10 are mounted on the carriage 5. In this embodiment, four valve units 11 are provided, each corresponding to the color, or to the kind, of ink to be used in the printer 1. On the lower surface of the recording head 10, nozzles are provided (not shown). Ink droplets are ejected through ejecting ports of the nozzles onto the paper which is conveyed over the platen 3.

A cartridge holder 12 is provided on the right end of the frame 2. Four cartridges 13, serving as liquid containers, are detachably mounted in the cartridge holder 12, As shown in FIG. 2, each cartridge 13 includes a case 14, the interior of which is airtight, and an ink pack 15 provided in the case 14. The ink pack 15 serves as a liquid-containing portion. Each ink pack 15 includes a flexible film that is formed into the shape of bag, and an ink supply port 15a that is made of synthetic resin. The ink packs 15 may be filled with a variety of inks. An inner space 17 is created between the case 14 and the ink pack 15.

As shown in FIG. 1, the ink supply port 15a of each ink pack 15 is connected to each of the valve units 11 provided on the carriage 5 by an ink supply passage 16 that serves as a liquid flow passage. Each ink supply passage 16 is comprised of a tube made of a flexible material or a flow passage that is formed by cutting a hard resin material.

A pressurizing unit 20 is mounted on the end portion of frame 2. The pressurizing unit 20 is a device for conveying air in a pressurized state as a fluid to the cartridges 13 by way of an air-supplying passage 21 that serves as a flow passage for fluid. The air-supplying passage 21 branches into plural passages (4 passages in this embodiment) at a distributor 26 that is located downstream in the pressurizing unit 20 and the branched passages 21 are connected to the respective cartridges 13.

As described above, an inner space 17 is provided between the case 14 and the ink pack 15 in each cartridge 13. In each case 14, a non-illustrated air-communicating hole which communicates with an inner space 17 is formed. Each of the air-supplying passages 21 (see FIG. 1) is connected to each air-communicating hole. Thus, air, conveyed as a fluid from the pressurizing unit 20 in a pressurized state, is introduced into each individual inner space 17 in the cartridge 13 via each air-supplying passage 21. When an inner space 17 is filled with air in a high pressure state, the ink pack 15 is crushed by the air pressure. This results in ink being pushed out of the ink pack 15 into the ink supply passage 16, so that ink is supplied to the valve unit 11.

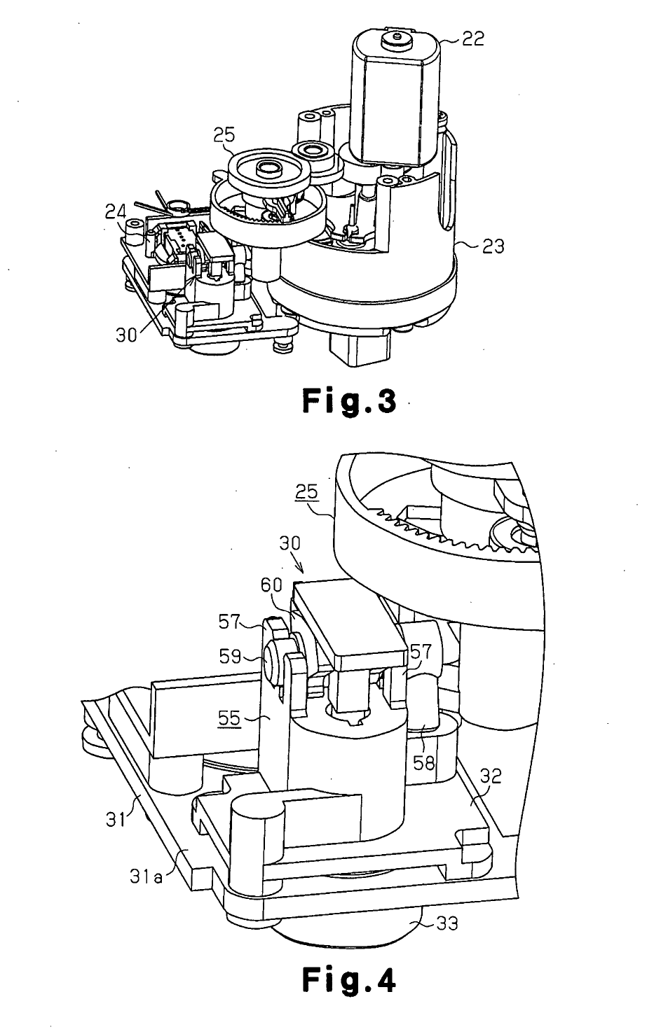

Next, the pressurizing unit 20 will be described with reference to FIG. 3. As illustrated in FIG. 3, the pressurizing unit 20 includes a drive motor 22, a pressurizing pump 23, a pressure sensor 24, and a pressure regulating valve 30 that serves as a valve device. The drive motor 22 is, for example, a stepping motor the drive shaft of which is connected to the pressurizing pump 23. When the drive motor 22 rotates normally, the pressurizing pump 23 conveys the pressurized air as a pressurized fluid to the cartridge 13. When the drive motor 22 rotates in a reverse direction, the pressurizing pump 23 does not convey the pressurized air to the cartridge 13.

A transmission mechanism 25 having tooth wheels is connected to the drive motor 22 to transmit the rotational force of the drive motor 22 to the pressure regulating valve 30. By virtue of the rotational force transmitted by the transmission mechanism 25, the pressure regulating valve 30 selectively opens and closes a part of the air flow passage that extends from the pressurizing pump 23 to the cartridge 13. Further, the pressure sensor 24 is located adjacent to the pressure regulating valve 30. The pressure sensor 24 detects the pressure of air conveyed by the pressurizing pump 23 and outputs the result of such detection to an external unit. When the pressure sensor 24 detects that the pressure of the pressurized air has decreased to a predetermined value or lower, it controls the drive motor 22 by means of the external unit to drive the pressurizing pump 23.

First, when the drive motor 22 rotates normally, the pressurizing pump 23 normally rotates to convey pressurized air to the pressure regulating valve 30 by the pressure sensor 24. When the pressure regulating valve 30 supplies ink in the cartridge 13 to the recording head 10, the valve 30 is closed so that the pressurized air is conveyed toward the cartridge 13. When the main power supply of the printer 1 is turned off, the valve 30 opens the air flow passage to the atmospheric air so as to release the air pressure applied to the ink pack 15, thereby preventing leakage of ink from the recording head 10. In contrast, when the pressure regulating valve 30 detects that the pressure of the pressurized air supplied to the cartridge 13 has increased to a predetermined value or higher, it automatically opens the air flow passage to the atmospheric air so as to release the pressurized air, and thus adjust the air pressure in the cartridge 13 so that it falls within a predetermined pressure range.

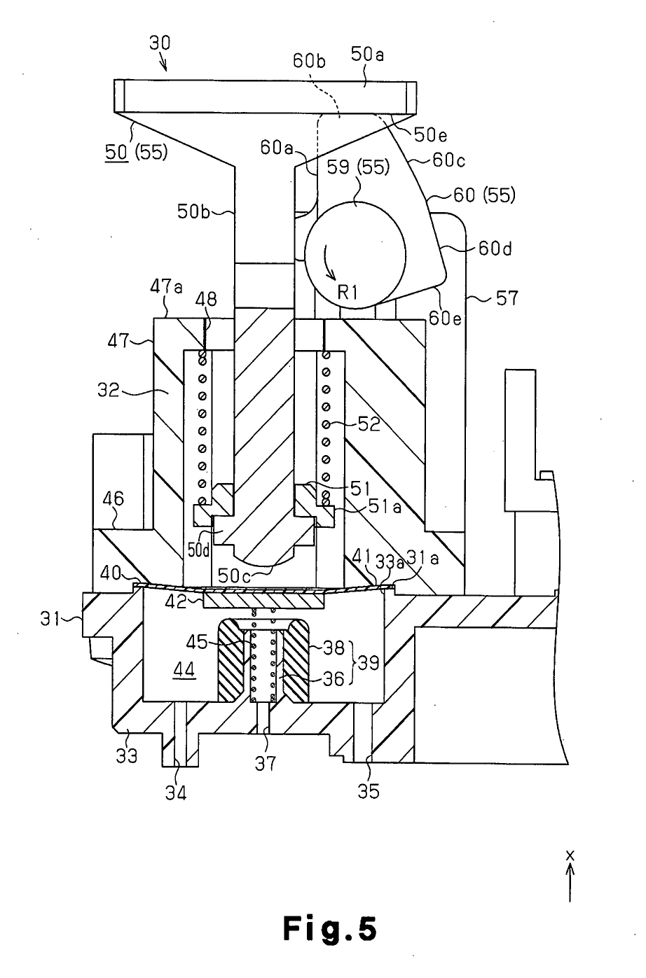

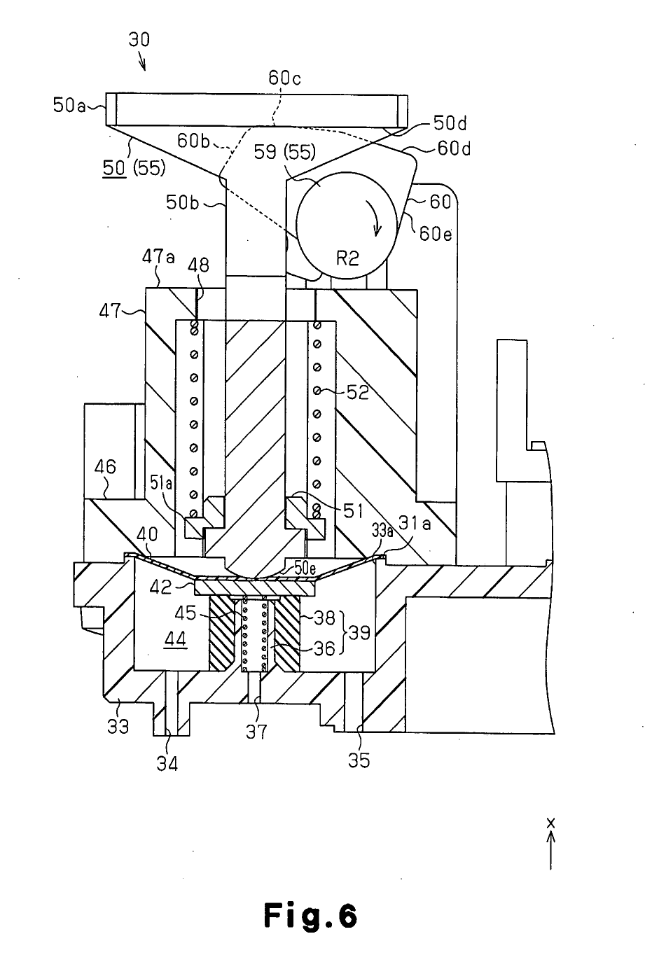

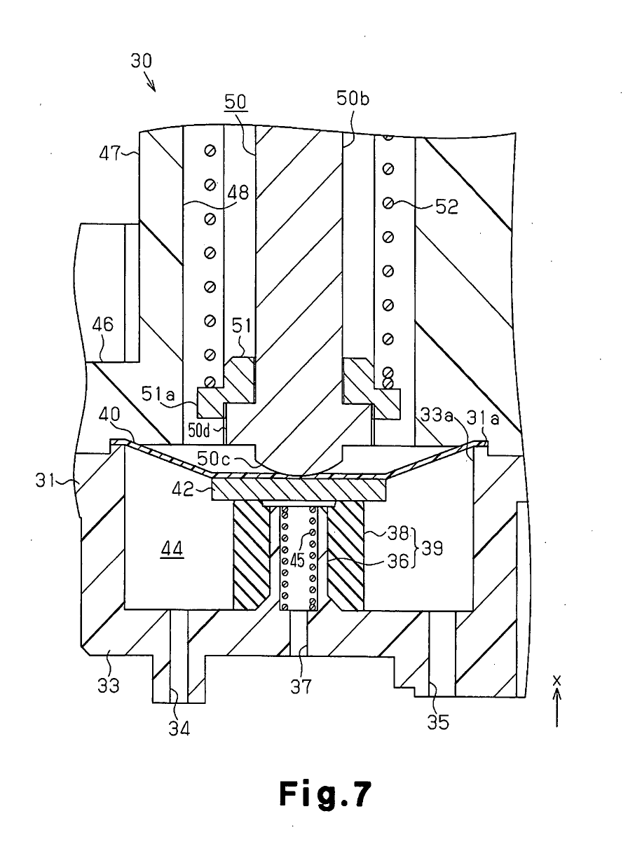

Next, the structure of the pressure regulating valve 30 will be described with reference to FIGS. 4 to 7. FIG. 4 is a perspective view of the pressure regulating valve 30. FIG. 5 is a cross-sectional view of the pressure regulating valve 30. FIGS. 6 and 7 are partially enlarged cross-sectional views of the pressure regulating valve 30. As shown in FIG. 4, the pressure regulating valve 30 includes a first cover 31 that is substantially in a plate-like shape and mounted integrally with the pressurizing pump 23 and the pressure sensor 24, and a second cover 32 that is mounted onto the first cover 31 from above. The first cover 31 and the second cover 32 are made of a synthetic resin such as polypropylene.

As shown in FIG. 5, the first cover 31 has a first housing 33 in the shape of a bottomed cylinder that extends in a longitudinal direction of the pressure regulating valve 30. An air introducing hole 34 and an air discharging hole 35 are respectively formed through the first cover 31 to be connected to the inside of the first housing 33. The air introducing hole 34 and the air discharging hole 35 together constitute an air flow passage that extends from the pressurizing pump 23 to the cartridge 13. The air introducing hole 34 is connected with the air flow passage of the pressurizing pump 23, whereas the air discharging hole 35 is connected with the air flow passage of the cartridge 13.

Further, a communicating portion 36 in the generally cylindrical shape is formed to protrude from the inner bottom surface of the first housing 33. An air communicating hole 37 that serves as a communicating hole is provided inside the communicating portion 36 and extends through the first housing 33. The air communicating hole 37 establishes a connection between the inside of the first housing 33 and the outside of the first housing 33, or of the first cover 31, in other words, the atmospheric air. A cylindrical sealing member 38 is provided around the communicating portion 36 to surround the communicating portion 36. The sealing member 38 is made of rubber or a synthetic resin, and its height (i.e. the height in the x direction in FIG. 5) is greater than the height of the communicating portion 36. The base end of the sealing member 38 is formed into a flat plate-like shape, and the top end thereof is formed into a tapered shape. The communicating portion 36 and the sealing member 38 together constitute a valve seat 39 to which a diaphragm 40 is brought into contact.

An opening 33a of the first housing 33 is covered with the diaphragm 40 which is displaceable in the x direction and the direction opposite to the x direction, as illustrated in FIG. 5. The diaphragm 40 includes a film 41 and a pressure receiving plate 42. The plate 42 serves as a contact member and is thicker than the film 41. The film 41 is made of a synthetic resin such as polyethylene which is weldable onto the first cover 31. The peripheral edge of the film 41 is welded onto the upper surface 31a of the first cover 31, so that the film 41 and the inner surface of the first housing 33 together constitute an air chamber 44 that serves as a storage chamber.

The pressure receiving plate 42 is made of a plate-like rubber or a synthetic resin, and is formed into the shape of a disc that is of a size sufficient to block the inlet of the air communicating hole 37 and the inlet of the sealing member 38. The pressure receiving plate 42 is pasted or welded onto substantially the central part of the film 41. In the valve closing state, the diaphragm 40, made up of the film 41 and the pressure-receiving plate 42, is applied the external force, with the result that the pressure-receiving plate 42 and the sealing member 38 make contact with each other, and thus block the air communicating hole 37. In the valve opening state, as the film 41 receives the pressure within the air chamber 44, the film 41 is displaced in a direction away from the valve seat 39, that is, in the x direction, and thus the air communicating hole 37 is opened. A “valve opening state” of the diaphragm 40 means not only a state where the pressure-receiving plate 42 is completely separated from the sealing member 38, but also a state where a clearance is formed between the pressure-receiving plate 42 and the sealing member 38. In other words, the valve opening state also includes a state where a part of the pressure-receiving plate 42 is separated from the sealing member 38 while, at the same time, another part thereof remains in contact with the sealing member 38.

A biasing spring 45, which is made of a coil spring that serves as a biasing member, is provided in the air communicating hole 37 of the communicating portion 36. In the valve opened state, the biasing spring 45 biases the pressure receiving plate 42 so as to expand the clearance between the pressure receiving plate 42 and the sealing member 38. As a result, when the diaphragm 40 moves away from the air communicating hole 37, the clearance between the sealing member 38 (i.e. an inlet of the air communicating hole 37) and the pressure receiving plate 42 is expanded.

As shown in FIGS. 4 and 5, the second cover 32 includes a plate-like attachment portion 46 and a second housing 47 that assumes the shape of a cylinder having a lid. A through hole 48 is formed through the cover portion 47a of the second housing 47. A switching member 50, which is comprised of a valve-closing unit, is passed through the through hole 48. The switching member 50 includes a plate-like engagement portion 50a and a penetrating portion 50b that extends downward from the engagement portion 50a and that penetrates through the second housing 47. A spherical contact portion 50c is formed on the lower end of the penetrating portion 50b. In the vicinity of the contact portion 50c, an annular protruding portion 50d is formed in a circumferential direction of the penetrating portion 50b.

Further, an annular spring receiving portion 51 is fitted with the annular protruding portion 50d of the switching member 50. An annular stepwise portion 51a is formed so as to protrude from the lower peripheral portion of the spring receiving portion 51. A coil spring 52 that serves as a biasing member is placed between the stepwise portion 51a of the spring receiving portion 51 and the cover portion 47a of the second housing 47. The coil spring 52 applies a biasing force onto the spring receiving portion 51 and the switching member 50 in the direction along which they are pressed against the diaphragm 40. The coil spring 52 is comprised of the valve-closing unit.

Further, an engagement piece 60 which constitutes a cam mechanism 55 that serves as a moving mechanism comes into contact with the lower surface 50e of the engagement portion 50a of the switching member 50. The cam mechanism 55 is comprised of the valve-closing unit. As shown in FIG. 4, the cam mechanism 55 is equipped with a pair of supporting portions 57 that have been formed so as to extend from the cover portion 47a of the second housing 47.

A rotational shaft 59 is rotatably supported by the supporting portions 57 and a drive lever 58 is connected to one end of the rotational shaft 59. The drive lever 58 is configured in such a way that, as it is driven by the transmission mechanism 25, as described above, it rotates only at a predetermined angle. Thus, the rotational shaft 59 rotates in accordance with the rotation of the drive lever 58.

As shown in FIG. 5, the rotational shaft 59 supports the engagement piece 60. The engagement piece 60 is formed into the shape of deformed polygon and has at least five sides. In this embodiment, the engagement piece 60 includes first to fifth sides 60a to 60e. The distances from the rotational shaft 59, which forms a center of rotation, to the first to fifth sides 60a to 60e differ from each other. For example, the distance between the second side 60b and the rotational shaft 59 is the longest. In contrast, the distance between the third side 60c and the rotational shaft 59 is relatively short.

For example, as shown in FIG. 5, in a state where the second side 60b of the engagement piece 60 is in contact with the lower surface 50e of the engagement portion 50a of the switching member 50, the engagement piece 60 pushes the switching member 50 upward in the x direction against the biasing force of the coil spring 52. At this point, the contact portion 50c of the switching member 50 is in a state in which it is separated from the diaphragm 40. Then, by virtue of the biasing force of the biasing spring 45 provided in the air communicating hole 37, the pressure-receiving plate 42 of the diaphragm 40 is pushed upward in a direction away from the valve seat 39, that is, in the x direction. As a result, a clearance is created between the pressure receiving plate 42 and the sealing member 38. The air chamber 44 is released to the atmospheric air, and in turn, the air flow passage that extends from the pressurizing pump 23 to the cartridge 13 is released to the atmospheric air.

When the rotational shaft 59 rotates in the direction R1, as shown in FIG. 5, that is, in a counterclockwise direction as the drive lever 58 rotates, the engagement piece 60 shifts from a state in which its second side 60b is in contact with the engagement portion 50a into the state in which its third side 60c is brought into contact with the engagement portion 50a. The distance between the rotational shaft 59 that acts as a center of rotation and the third side 60c that is in contact with the engagement portion 50a is reduced, and the switching member 50 is thereby depressed downward in the direction opposite to the x direction by the biasing force of the coil spring 52. The biasing force of the coil spring 52 is set to be larger than the biasing force of the biasing spring 45.

The switching member 50, depressed downward in the direction opposite to the x direction by the biasing force of the coil spring 52, causes its contact portion 50c to press the diaphragm 40 against the sealing member 38. As a result, the pressure-receiving plate 42 crushes the top end of the sealing member 38 so as to create a valve closed state in which the air communicating hole 37 is blocked. Thus, the air flow passage that extends from the pressurizing pump 23 to the cartridge 13 comes into an air-tight state without being released to the atmospheric air. The pressurized air supplied from the pressurizing pump 23 is conveyed into the inner space 17 of the cartridge 13 in a pressurized state.

Next, operation of the pressurizing unit 20 will be described. When the main power supply of the printer 1 is in an off state, the pressure regulating valve 30 is open, as shown in FIG. 5. If the pressure regulating valve 30 is in a closed state when the power supply is off, the air filling the cartridge 13 may pressurize the ink pack 15 to cause the ink to leak out of an ink supply port (not shown) that is formed on the cartridge 13, or out of the recording head 10. Further, the pressurized air in the cartridge 13 may press the cartridge 13 against the cartridge holder 12 so as to make it difficult to remove the cartridge 13 from the cartridge holder 12. To avoid these problems, even after the main power supply of the printer 1 has turned off, the supply of electric power to the power supply circuit is continued for a predetermined time period by use of a delay circuit or the like, and during this period, the drive motor 22 is rotated reversely. Reverse rotation of the drive motor 22 causes the pressure regulating valve 30 to open by means of the transmission mechanism 25.

When the main power supply of the printer 1 is turned on and printing is started, the drive motor 22 rotates normally. The rotational force of the drive motor 22 is transmitted to the cam mechanism 55 by means of the transmission mechanism 25 to drive the drive lever 58 of the cam mechanism 55 to rotate normally. As the drive lever 58 rotates normally, the rotational shaft 59 rotates in the direction of R1, in other words, in the counterclockwise direction illustrated in FIG. 5. As a result, the engagement piece 60 moves out of a state where its second side 60b, which is separated a long distance away from the center of rotation, is in contact with the lower surface of the engagement portion 50a, into a state illustrated in FIG. 6 where its third side 60c, which is separated by a relatively short distance from the center of rotation, is brought into contact with the lower surface of the engagement portion 50a. As a result, the switching member 50 shifts from a state where it is pushed upward by the engagement piece 60 into the state where, by virtue of the biasing force of the coil spring 52, it approaches the diaphragm 40, in other words, it is depressed downward in the direction opposite to the x direction. At the same time, as shown in FIG. 6, the contact portion 50c of the switching member 50 pushes the diaphragm 40 against the sealing member 38, and in consequence, the pressure-receiving plate 42 is pressed against the sealing member 38 so as to make contact with the sealing member 38 in the face of the biasing force of the biasing spring 45 disposed in the air communicating hole 37, as shown in FIG. 7. As a result, the air communicating hole 37 is blocked, and in consequence, the pressure regulating valve 30 is closed.

As described above, the drive lever 58 is configured to rotate only at a predetermined angle by, for example, means of a restricting member provided on the transmission mechanism. Thus, even if the drive motor 22 further rotates normally, further rotational force to be transmitted to the pressure regulating valve 30 is prevented.

As the drive motor 22 further rotates normally, the pressurizing pump 23 conveys the pressurized air toward the cartridge. The air supplied from the pressurizing pump 23 is sent to the pressure sensor 24 through the air flow passage. The pressure sensor 24 detects the air pressure in the passage between the pressurizing pump 23 and the cartridge 13. If the pressure detected exceeds a predetermined upper limit value P1, the pressure sensor 24 outputs the detection signal of the upper limit value P1 to a non-illustrated control circuit that is provided in the printer 1.

The pressurized air supplied from the pressure sensor 24 flows through the air introducing hole 34 of the pressure regulating valve 30 into the air chamber 44. If the air pressure in the air chamber 44 is at a predetermined value or lower, the air in the air chamber 44 is discharged through the air discharging hole 35 and sent to the cartridge 13 by way of the air passage. The pressurized air charged into the inner space 17 of the cartridge 13 crushes the ink pack 15, and the ink in the ink pack 15 is in turn pushed into the ink supply passage 16. The ink supplied to the ink supply passage 16 is then supplied to the recording head 10, from which ink is ejected toward paper by driving a piezoelectric element (not shown).

During time periods when the pressurized air is supplied from the pressurizing pump 23, or the pressurized air supplied from the pressurizing pump 23 is stopped, the control circuit described above controls the pressurizing unit 20 based on the pressure detected by the pressure sensor 24, in such a manner that the pressure of the air supplied to the cartridge 13 falls within an appropriate range that conforms with the state of the printer 1.

Specifically, when the pressure sensor 24 detects that the pressure exceeds the upper limit value P1, the pressure sensor 24 terminates rotation of the drive motor 22 to stop the pressurizing pump 23 and to prevent further application of pressure onto the interior of the cartridge 13. The pressure regulating valve 30 is held in a closed state. Further, when the pressure sensor 24 detects that the pressure is below the lower limit value P2 while the pressurizing pump 23 is stopped, the control circuit controls the drive motor 22 so as to rotate normally, and thus drive the pressurizing pump 23 to supply air in a pressurized state.

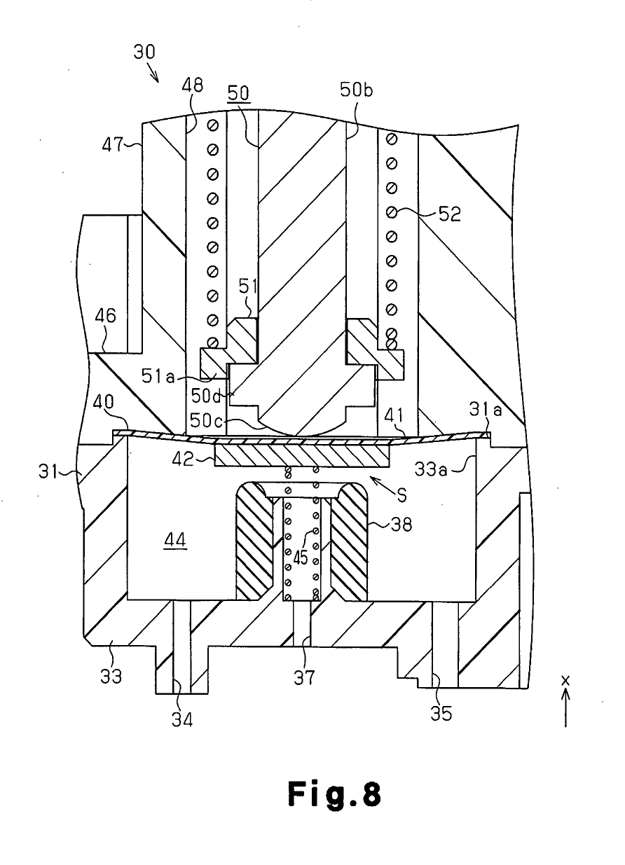

The pressure regulating valve 30 also serves as an air release valve which, even when the pressure sensor 24 or the control circuit breaks down or makes an erroneous detection while the pressurizing pump 23 is supplying pressurized air, prevents excessive pressure from occurring in the air flow passage that extends from the pressurizing pump 23 to the cartridge 13. As described above, the film 41 is provided so as to be displaceable both in a direction moving away from the valve seat 39, or the x direction, and in a direction approaching toward the valve seat 39, or the direction opposite to the x direction. Thus, if the pressure inside the air chamber 44 of the pressure regulating valve 30 exceeds the threshold value Pa that serves as a predetermined value, the sum of the pressing force resulting from the pressurized air from the air chamber 44 and the biasing force of the biasing spring 45 that is disposed in the air communicating hole 37 exceeds the biasing force applied by the coil spring 52. As a result, as shown in FIG. 8, the film 41 is displaced in the x direction and a clearance S, which is expanded by the biasing spring 45, is formed between the pressure receiving plate 42 and the sealing member 38 (an atmospheric air release state).

The biasing force and the length of the biasing spring 45 are set to such values that enable the clearance S between the pressure-receiving plate 42 and the sealing member 38 to be a size that does not cause vibration or unusual sounds. As a result, when the air passes through the clearance S, the air in the air chamber 44 flows through the air communicating hole 37 without making the film 41 or the pressure receiving plate 42 vibrate and without generating turbulence of the kind that causes unusual sounds, and then, the pressure within the air chamber 44 and the air flow passage is decreased to the level of atmospheric pressure. Thus, any breakages of the cartridge 13 and the air supply passage 21 can be prevented.

When the pressure regulating valve 30 is closed, the printer 1 terminates printing and the power supply is turned off, the supply of electric power to the power supply circuit may be maintained by use of a device such as a delay circuit. While this state is maintained, the drive motor 22 is rotated in a reverse direction. As described above, the drive lever 58 of the cam mechanism 55 then rotates in a reverse direction so as to bring the second side 60b of the engagement piece 60 into contact with the switching member 50 as shown in FIG. 5. Thus, the switching member 50 is pushed upward in a direction moving away from the sealing member 38 and, by virtue of the biasing force applied by the spring force 45, the diaphragm 40 is brought into an valve opening state.

The embodiment described above has the following advantages.

The pressure regulating valve 30 includes a diaphragm 40 that is comprised of the film 41 and the pressure receiving plate 42 and an air chamber 44 that is comprised of a first housing 33 and a diaphragm 40. Further, the pressure regulating valve 30 also includes a biasing spring 45 in the air communicating hole 37 of the communicating portion 36. The biasing force of the biasing spring 45 is suppressed to a level where the clearance S that is formed between the pressure receiving plate 42 and the sealing member 38 when the valve is opened does not cause vibration or unusual sounds as a result of air flowing through the air communicating hole 37 to occur. Thus, even when the film 41 is used for the diaphragm 40, occurrence of vibration or unusual sounds caused by the air flow in the valve opened state can be prevented. Further, since the diaphragm 40 is made of the film 41, costs can be reduced more than a case where a rubber molded article is used.

The biasing spring 45 is housed in the air communicating hole 37. Thus, space can be reduced to a greater extent than in a case where the biasing spring 45 is disposed around the communicating portion 36.

The pressure regulating valve 30 includes a switching member 50 that forces the diaphragm 40 to displace to a position where it is in contact with the sealing member 38, and a cam mechanism 55 for driving the switching member 50. Thus, the pressure regulating valve can also serve as a regulator for adjusting pressure inside the air flow passage.

A drive motor 22 is provided which serves as both the driving source for the pressurizing pump 23 and the driving source for forcing the pressure regulating valve 30 to selectively open and close. Thus, the driving source of the pressurizing pump 23 can be effectively utilized and there is no need for a plurality of pumps for generating pressurized air.

The pressure regulating valve 30 is mounted in the printer 1. This structure is especially effective in that the vibration and unusual sounds can be suppressed in the printer 1 for which quietness there is required.

The embodiment as described above may be varied as follows.

The pressurizing unit 20 may further include a pressure detection device for detecting a pressure value. When a pressure value outputted from the pressure detection device exceeds a permitted air pressure, the control circuit may control the drive motor 22 so to rotate in a reverse direction and open the pressure regulating valve 30 to protect the cartridge 13, the air supply passage 21, or other parts from breakage. In such circumstances, the control circuit controls the drive motor 22 so as to rotate in a reverse direction. When the drive motor 22 rotates in a reverse direction, the drive lever 58 rotates in an opposite direction by means of the transmission mechanism 25. In response to this, the rotational shaft 59 rotates in the direction R2 in FIG. 6 (in the clockwise direction in FIG. 6) so as to cause the engagement piece 60 to move away from a state in which its third side 60c is in contact with the engagement portion 50a to a state in which its second side 60b is in contact with the engagement portion 50a, as shown in FIG. 5. The engagement piece 60 pushes the switching member 50 upward against the biasing force of the coil spring 52. Accordingly, the switching member 50 moves in an upward direction moving away from the sealing member 38 so as to bring the diaphragm 40 into a state in which it is separated from the sealing member 38. Accordingly, by effectively utilizing the pressure regulating valve 30, pressure inside the air flow passage can be controlled with greater precision.

Instead of providing the drive motor 22, the pressurizing pump 23, the pressure sensor 24, and the pressure regulating valve 30 in the pressurizing unit 20 integrally by the first and second covers 31, 32, they may be separately provided.

The engagement piece 60 may also assume any shape other than the shapes described above, such as a rectangular shape and a hexagonal shape.

The sealing member 38 may be omitted.

Instead of in the air communicating hole 37, the biasing spring 45 may be provided, at other positions such as in the space between the bottom surface of the first housing 33 and the film 41, or on the outside of the communicating portion 36.

The biasing spring 45 may be any other spring such as a stretching spring. Alternatively, the biasing member may be any other elastic member, other than a spring, such as a rubber member.

The coil spring 52 may be provided so as to bias the switching member 50 toward the valve opening position. For example, the coil spring 52 may be interposed between the second housing 47 and the engagement portion 50a of the switching member 50. Further, the cam mechanism 55 may be any other mechanism than the cam, as long as it is a mechanism that is capable of moving the switching member 50 to a valve closing position against the biasing force of the coil spring 52.

The switching member 50 for selectively opening and closing the diaphragm 40 may also be a plunger that is driven by the passage or breakage of electric current to the solenoid. This eliminates the cam mechanism 55 and control of the valve-opening operation and the valve closing operation is facilitated.

The fluid that is sent from the pressurizing pump 23 to the cartridge 13 may be liquid.

The printer 1 may also be any printer other than an ink-jet printer, such as a heat transfer printer.

The pressure regulating valve 30 may be mounted in devices other than the printer 1 and the liquid ejection device.

The liquid ejection device is not limited to the printer 1. Alternatively, the liquid ejection device may be a device for manufacturing a color filter such as a liquid crystal display, a device for forming an electrode such as an organic EL display and a flat emitting display (FED), a jet device for jetting biological organic substances for manufacturing bio-chips, and a device for manufacturing precise pipettes.

The present examples and embodiments are to be considered as illustrative and not restrictive and the invention is not to be limited to the details given herein, but may be modified within the scope and equivalence of the appended claims.

What is claimed is:

1. A valve device, comprising:
a flow passage, a fluid passing through the flow passage;
a storage chamber disposed in the flow passage for storing the fluid, the storing chamber including an opening;
a valve seat including a communicating hole for releasing the fluid in the storage chamber through the communicating hole to the outside;
a diaphragm that operates to cover the opening of the storage chamber and that displaces relative to the valve seat;
a valve-closing unit for bringing the diaphragm into contact with the valve seat so as to block the communicating hole; and
a first biasing member for expanding a clearance between the diaphragm and the valve seat to open the valve device.

2. The valve device according to claim 1, wherein the diaphragm includes a film and a contact member attached to the film, wherein the film warps in conformity with differences in pressure between inside and outside of the storage chamber and the contact member operates to come into contact with the valve seat.

3. The valve device according to claim 1, wherein the valve seat is formed into a shape of a cylinder, and the biasing member is disposed on the inside of the valve seat.

4. The valve device according to claim 1, the valve-closing unit comprising:
a switching member that is movable between the valve opening position in which the switching member fails to press the diaphragm and the valve closing position in which the switching member presses the diaphragm, wherein the switching member brings the diaphragm and the valve seat into contact with each other in the valve closing position to bring the diaphragm into a valve closing state;
a second biasing member for biasing the switching member toward the valve closing position; and
a moving mechanism for moving the switching member between a valve opening position and a valve closing position,
wherein, when pressure inside the storage chamber has reached a predetermined value by the pressure of the fluid, the first biasing member brings the diaphragm into a valve opening state against the second biasing force by means of pressure of the fluid and the biasing force of the first biasing member.

5. A valve device for regulating a pressure of the fluid passing through a flow passage comprising:
a housing disposed in the flow passage, the housing having an inlet hole and an outlet hole;
a storage chamber disposed in the housing for storing the fluid, the storing chamber including an opening, the fluid is introduced into the storage chamber through the inlet hole and discharged from the storage chamber through the outlet hole;
a valve seat extending into the storage chamber, the valve seat including a communicating hole for releasing the fluid in the storage chamber through the communicating hole to the outside;
a diaphragm that operates to cover the opening of the storage chamber and that displaces relative to the valve seat;
a valve-closing unit for bringing the diaphragm into contact with the valve seat so as to block the communicating hole; and
a first biasing member disposed on the inside of the valve seat, the first biasing member biasing the diaphragm for expanding a clearance between the diaphragm and the valve seat to open the valve device.

6. The valve device according to claim 5, wherein the diaphragm includes a film and a contact member attached to the film, wherein the film warps in conformity with differences in pressure between inside and outside of the storage chamber and the contact member operates to come into contact with the valve seat.

7. A liquid ejection device comprising:
a liquid container having a case and a liquid-containing portion;
a liquid ejection head being connected to the liquid container through a liquid flow passage, the liquid ejection head being capable of ejecting the liquid; and
a pressurizing unit for conveying a pressurized liquid in a fluid flow passage that extends between the pressurizing unit and the liquid container to supply the pressurized liquid between the case and the liquid-containing portion of the liquid container so as to cause the liquid in the liquid-containing portion out of the liquid flow passage, the pressurizing unit comprising:
a pressurizing pump for pushing the pressurized fluid into the fluid flow passage; and
a valve device for regulating the pressure of the pressurized fluid pushed out of the pressurized pump, the valve device comprising:
a storage chamber disposed in the fluid flow passage for storing the pressurized fluid, the storing chamber including an opening;
a valve seat including a communicating hole for releasing the pressurized fluid in the storage chamber through the communicating hole to the outside;
a diaphragm that operates to cover the opening of the storage chamber and that displaces relative to the valve seat;
a valve-closing unit for bringing the diaphragm into contact with the valve seat so as to block the communicating hole; and
a first biasing member for expanding a clearance between the diaphragm and the valve seat to open the valve device.
